(19) United States
(12) Patent Application Publication
(10) Pub. No.: US 2016/0255149 A1
(43) Pub. Date: Sep. 1, 2016

(54) Mirror links

(71) Applicant: Michael Lewis Moravitz, Fairfax, VA (US)

(72) Inventor: Michael Lewis Moravitz, Fairfax, VA (US)

(21) Appl. No.: 14/999,167

(22) Filed: Apr. 7, 2016

(51) Int. Cl. H04L 29/08

(52) U.S. Cl. CPC H04L 67/1095

(57) ABSTRACT

To avoid cumbersome websites with many links that require much bandwidth to download, websites should have mirror links—similar to hyperlinks—but linking separate parts of a website that would be saved and accessed on different servers.

Trunkloads—overloaded websites—make the sites harder to download not only in the United States and other developed countries but also in the developing world and in emerging economies with many potential readers and customers.

Websites might be configured with “mirror links”—similar to hyperlinks—but within the same site. In other words, you would create essentially an intranet for your website in which different sections would be linked—but be saved and accessed on different servers. This would improve download speeds and availability, increasing profitability.

1. Builds on patents for hyperlinks; and

2. Servers for websites.
